(19) United States
(12) Patent Application Publication
(10) Pub. No.: US 2006/0291812 A1
(43) Pub. Date: Dec. 28, 2006

(54) Apparatus and method for reproducing moving image data

(75) Inventor: Satoshi Takezaki, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/451,346

(22) Filed: Jun. 13, 2006

(30) Foreign Application Priority Data
Jun. 28, 2005 (JP) 2005-188494

(51) Int. Cl. H04N 7/00

(52) U.S. Cl. 386/95

(57) ABSTRACT

According to one embodiment, a memory stores a plurality of application programs including a moving image reproducing application program. The moving image reproducing application program includes an image-quality improving routine capable of selecting an amount of data processing for an image-quality process of improving image quality of a moving image. A processor executes the application programs concurrently. A load detecting unit detects an amount of load on the processor. A determining unit determines the optimum amount of data processing for an image-quality process, which is performed by the image-quality improving routine, in accordance with the system condition including the amount of load on the processor detected by the load detecting unit.

### CROSS-REFERENCE TO RELATED APPLICATIONS

This application is based upon and claims the benefit of priority from Japanese Patent Application No. 2005-188494, filed Jun. 28, 2005, the entire contents of which are incorporated herein by reference.

### BACKGROUND

1. Field

One embodiment of the invention relates to an apparatus and method for reproducing moving image data. More specifically, the embodiment relates to an apparatus and method for reproducing moving image data by executing moving image reproducing application programs.

2. Description of the Related Art

Personal computers having a moving image reproducing application function of reproducing moving image data (moving image) have recently been developed. In order to process a large amount of data such as moving images in the personal computers, no images are reproduced or displayed at regular time intervals unless high performance is secured for a CPU (processor) and buses. In other words, an image may be displayed unnaturally depending on the load conditions of the CPU and buses. In order to prevent an image from being displayed unnaturally, a time interval for displaying a frame can be varied. A reproduced image can thus be displayed smoothly. If, however, the time interval is varied, a time period for reproducing a series of moving images is not fixed or does not match the original reproduction time period.

Jpn. Pat. Appln. KOKAI Publication No. 10-13794 discloses a moving image reproducing apparatus capable of reproducing a moving image smoothly with a time period for reproducing the moving image conforming to the original reproduction time period (referred to as prior art 1 hereinafter). The apparatus of prior art 1 includes a decoding process unit for decoding compressed image data and a display process unit for transferring a decoded frame to a display device. These units are provided independently of each other. Thus, a displayed image can be updated at regular time intervals. When decoding is not in time for updating, a frame is eliminated. When decoding is earlier than updating, it is stopped. In prior art 1, a frame to be eliminated is selected and a frame is transmitted at regular time intervals to allow a moving image to be reproduced smoothly.

In personal computers having a moving image reproducing application function, a microprocessor processes an image to reproduce a moving image in accordance with a moving image reproducing application program. If, however, the load of image processing on the microprocessor increases, the processing will be delayed, resulting in degradation of image quality due to a drop in frame.

Jpn. Pat. Appln. KOKAI Publication No. 2002-314951 discloses a technique of changing image processing of high load to image processing of low load if the load of processing on a microprocessor heightens (referred to as prior art 2 hereinafter). The technique of prior art 2 allows image processing without causing a sudden degradation of image quality due to a drop in frame.

Prior art 1 relates to a basic function of reproducing a moving image and does not pay attention to a function of processing the image quality of a moving image. In other words, a moving image can be reproduced smoothly by transmitting a frame at regular time intervals, but its image quality is not necessarily good.

In prior art 2, as image processing increases in load, it changes to image processing of low load. Even though the load on image processing is simply high, the processing of a CPU (microprocessor) is not necessarily delayed. In prior art 2, image processing of high load inevitably changes to image processing of low load even when the CPU reserves a capacity for data processing. Though the image processing of high load can be performed, the image processing of low load is likely to degrade the quality of a moving image.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing an exemplary outward appearance of a personal computer according to an embodiment of the invention;

FIG. 2 is a block diagram of an exemplary system configuration of the personal computer shown in FIG. 1;

FIG. 3 is a block diagram of an exemplary function configuration of a moving image reproducing application program shown in FIG. 1;

FIG. 4 is a view illustrating an exemplary data structure of a parameter table shown in FIG. 2;

FIG. 5 is a view illustrating an exemplary data structure of a function pointer table shown in FIG. 2;

FIG. 6 is a view illustrating an exemplary data structure of a function skip flag table shown in FIG. 2;

FIG. 7 is a flowchart of an exemplary procedure of a battery checking routine shown in FIG. 2;

FIG. 8 is a flowchart of an exemplary procedure of a CPU load amount checking routine shown in FIG. 2;

FIG. 9 is a flowchart of an exemplary procedure of a determining routine shown in FIG. 2; and

FIG. 10 is a flowchart of a procedure executed by an image-quality improving routine calling unit shown in FIG. 2.

### DETAILED DESCRIPTION

Various embodiments according to the invention will be described hereinafter with reference to the accompanying drawings. In general, according to one embodiment of the invention, there is provided an information processing apparatus that reproduces moving image data. The information processing apparatus comprises a memory which stores application programs including a moving image reproducing application program to reproduce moving image data, the moving image reproducing application program including an image-quality improving routine in which an amount of data processing for an image-quality process of improving image quality of a moving image is changed, a processor which executes the application programs concurrently with each other, a load detecting unit configured to detect an amount of load on the processor, and a determining unit configured to determine an optimum amount of data processing for the image-quality process executed by the image-quality improving routine, in accordance with a system condition including the amount of load on the processor detected by the load detecting unit.

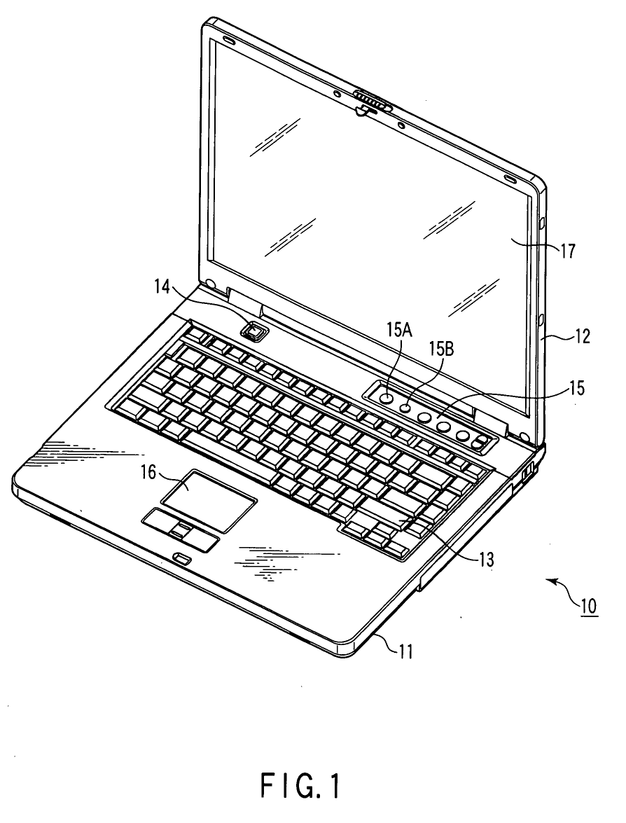

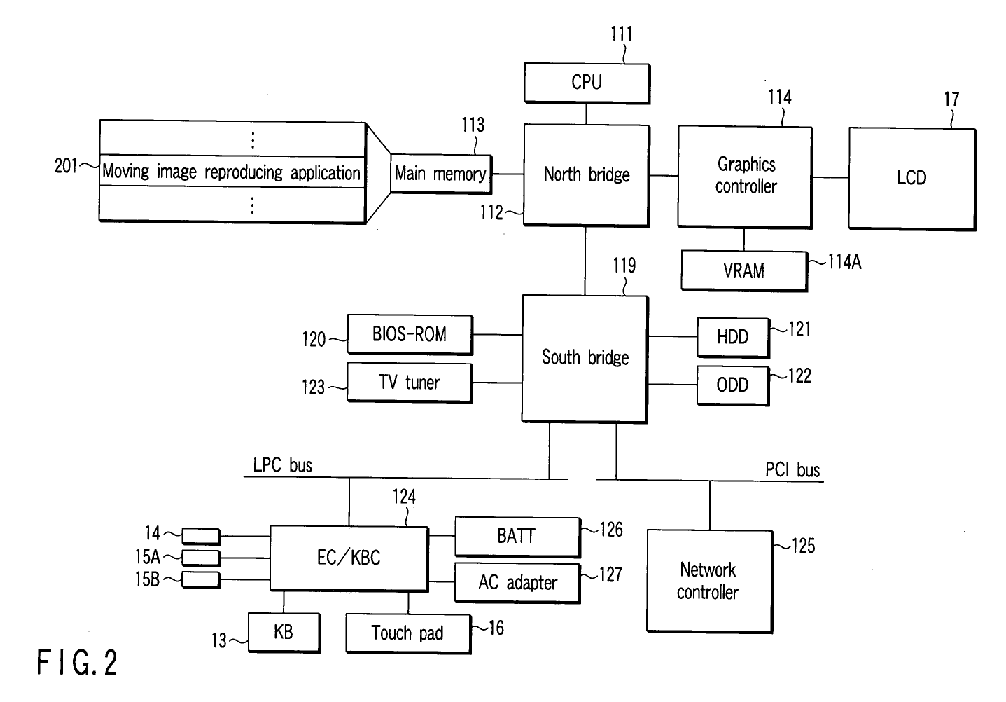

An embodiment of the invention will be described with reference to the accompanying drawings. Referring first to FIGS. 1 and 2, the configuration of an information processing apparatus according to the embodiment will be described. The information processing apparatus is implemented as, for example, a notebook personal computer 10.

FIG. 1 is a perspective view of the notebook personal computer 10 whose display unit is open. The computer 10 includes a main body 11 and a display unit 12. The display unit 12 incorporates a display device that is composed of a thin film transistor liquid crystal display (LCD) 17. The display screen of the LCD 17 is located in almost the central part of the display unit 12.

The display unit 12 is attached to the main body 11 such that it can turn between its open position and closed position. The main body 11 has a thin box-shaped housing. A keyboard 13, a power button 14, an input operation panel 15 and a touch pad 16 are arranged on the top surface of the main body 11. The power button 14 is used to power on/power off the computer 10.

The input operation panel 15 is an input device for inputting an event corresponding to a depressed button. The panel 15 includes a plurality of buttons for starting their respective functions. These buttons include a television (TV) start button 15A and a DVD/CD start button 15B. The TV start button 15A is used to start a TV function of reproducing, viewing and recording TV broadcast program data. When a user depresses the TV start button 15A, a moving image reproducing application program for performing the TV function starts.

The computer 10 is installed with a sub-operating system dedicated to audio/video (AV) data processing as well as a general-purpose main operating system. The moving image reproducing application program is a program that runs on the sub-operating system.

When the user depresses the power button 14, the main operating system starts. When the user depresses the TV start button 15A, not the main operating system but the sub-operating system starts. As the sub-operating system starts, the moving image reproducing application program is automatically executed. The sub-operating system has only the minimum function of carrying out an AV function. Thus, a time period required for booting up the sub-operating system is much shorter than a time period required for booting up the main operating system. The user can view/record a TV program promptly by simply depressing the TV start button 15A.

The DVD/CD start button 15B is a button for reproducing, e.g., video contents from digital versatile disc (DVD) media or compact disc (CD) media. Even when the user depresses the DVD/CD start button 15B, the moving image reproducing application program starts. The moving image reproducing application program runs on the sub-operating system as described above. Even when the user depresses the DVD/CD start button 15B, not the main operating system but the sub-operating system starts and the moving image reproducing application program is automatically executed.

Referring then to FIG. 2, the system configuration of the computer 10 will be described. As shown in FIG. 2, the computer 10 includes a CPU 111, a north bridge 112, a main memory 113, a graphics controller 114, a south bridge 119, a BIOS-ROM 120, a hard disk drive (HDD) 121, an optical disk drive (ODD) 122, a TV tuner 123, an embedded controller/keyboard controller IC (EC/KBC) 124 and a network controller 125.

The CPU 111 is a processor for controlling an operation of the computer 10. The CPU 111 executes the main operating system/sub-operating system and various application programs such as a moving image reproducing application program 201. The main operating system/sub-operating system and the application programs are loaded into the main memory 113 from the HDD 121. FIG. 2 shows the moving image reproducing application program 201 that is loaded into the main memory 113.

The moving image reproducing application program 201 includes a processing routine for reproducing, viewing and recording TV broadcast program data. The program 201 also includes a processing routine for recording, e.g., TV broadcast program data on DVD media or CD media and reproducing data therefrom. The program 201 has a basic function of reproducing a moving image in the TV broadcast program data. The program 201 also has a function of performing the optimum image-quality process to improve (enhance) the image quality of a moving image in accordance with the load on the CPU 111 (load on the system) and the condition of the power supply of the computer 10 at the time of reproduction of the moving image.

The CPU 111 executes a Basic Input Output System (BIOS) stored in the BIOS-ROM 120. The BIOS is a program for controlling hardware. The north bridge 112 is a bridge device that connects a local bus of the CPU 111 and the south bridge 119. The north bridge 112 incorporates a memory controller for controlling access to the main memory 113. The north bridge 112 has a function of communicating with the graphics controller 114 via an accelerated graphics port (AGP) bus and the like.

The graphics controller 114 serves as a display controller and controls the LCD 17 that is used as a display monitor of the computer 10. The graphics controller 114 displays video data written to the video memory (VRAM) 114A on the LCD 17.

The south bridge 119 controls devices on a Low Pin Count (LPC) bus and devices on a Peripheral Component Interconnect (PCI) bus. The south bridge 119 incorporates an Integrated Drive Electronics (IDE) controller for controlling the HDD 121 and ODD 122. The south bridge 119 has a function of controlling the TV tuner 123 and a function of gaining access to the BIOS-ROM 120.

The HDD 121 is a storage device for storing various types of software and data. The ODD 122 is a drive unit for driving optical disk media that stores video contents and the like. The ODD 122 is able to drive both DVD media and CD media as the optical disk media. The TV tuner 123 is a receiving device for receiving broadcast program data such as TV broadcast programs from outside.

The EC/KBC 124 is a single-chip microcomputer on which an embedded controller (EC) for managing power and a keyboard controller for controlling the keyboard (KB) 13 and the touch pad 16 are integrated. The EC/KBC 124 has a function of powering on/powering off the computer 10 in accordance with a user's depression of the power button 14. In the present embodiment, the operating power supply voltage (DC power supply voltage) applied to each components of the computer 10 is generated from a battery 126 included in the computer 10 or an external power supply voltage (AC power supply voltage) applied from outside via an AC adapter 127.

Further, the EC/KBC 124 is able to turn on the computer 10 by user's depression of the TV start button 15A or DVD/CD start button 15B. The network controller 125 is a communication device that performs communications with an external network such as the Internet.

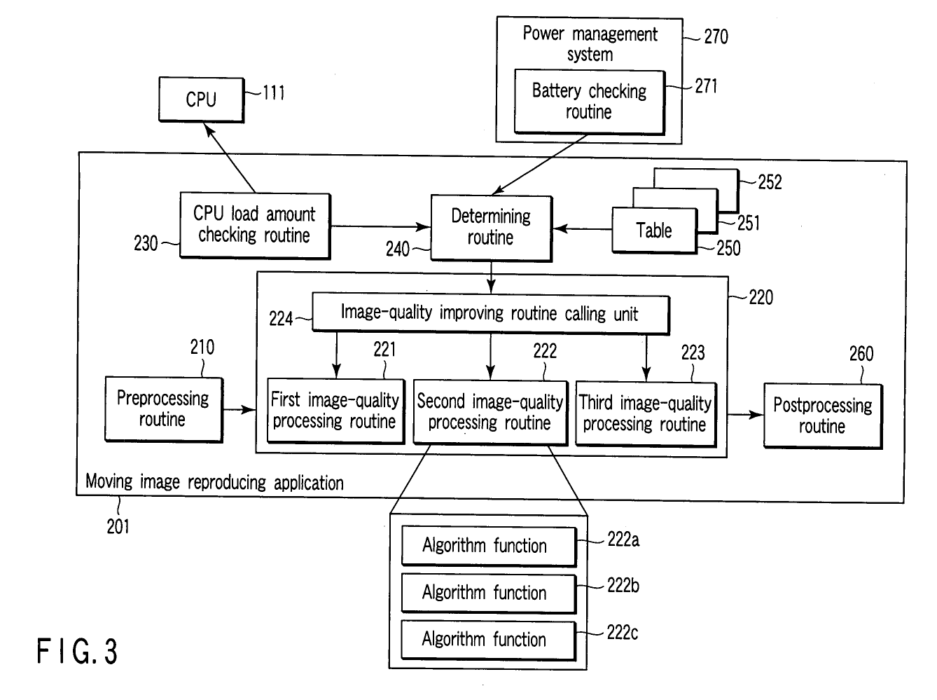

FIG. 3 is a block diagram showing a function configuration of the moving image reproducing application program 201. Referring to FIG. 3, the moving image reproducing application program 201 includes a preprocessing routine 210, an image-quality improving routine 220, a CPU load amount checking routine 230, a determining routine 240, a parameter table 250, a function pointer table 251, a function skip flag table 252 and a postprocessing routine 260. The program 201 is executed by the CPU 111, as are the routines 210, 220, 230, 240 and 260 included in the program 201. For the sake of brevity, the embodiment will be described hereinafter on the assumption that the program 201 and routines 210, 220, 230, 240 and 260 in themselves perform their processes.

As described above, the moving image reproducing application program 201 performs the optimum image-quality process in accordance with the system conditions, namely, the conditions of the load on the CPU 111 and the power supply of the computer 10 at the time of reproduction of a moving image. A notification about the condition of the power supply is provided by a battery checking routine 271 that runs on a power management system 270. The power management system 270 is implemented by the operating systems, BIOS, embedded controller (EC), and the like.

The battery checking routine 271 performs a process of determining which of alternating current (AC) driving mode P1 and battery driving mode P2 is used to drive the computer 10. In AC driving mode P1, the computer 10 is driven by (a DC power supply voltage generated from) an AC power supply voltage applied to the AC adapter 127 from outside. In battery driving mode P2, the computer 10 is driven by the battery 126.

The battery checking routine 271 also performs a process of periodically checking the amount of power remaining in the battery 126. The routine 271 detects a selection between the driving modes and a variation (increase/decrease) in the amount of power remaining in the battery 126 (remaining amount of battery power) as the conditions of the power supply of the computer 10. In other words, the routine 271 serves as a power supply condition detecting unit. When one of the driving modes is selected or the remaining battery power is varied, the routine 271 performs a process of notifying the determining routine 240 of the currently-selected driving mode or the current remaining battery power.

The preprocessing routine 210 performs a preprocess of reproducing a moving image. More specifically, the routine 210 decodes a compressed image of, e.g., the Moving Picture Coding Experts Group 2 (MPEG2) standard, which is received and encoded by the TV tuner 123, into a frame image. The image-quality improving routine 220 performs a process of improving the image quality of a moving image by the optimum amount of data processing for the system conditions at the time of reproduction of the moving image. The routine 220 includes a first image-quality processing routine 221, a second image-quality processing routine 222, a third image-quality processing routine 223 and an image-quality improving routine calling unit 224.

The first image-quality processing routine 221 varies an amount of data processing in, for example, image data conversion, using a variable Pa, which reflects the current system conditions, as a parameter. The second image-quality processing routine 222 has a plurality of algorithm functions (image-quality improving algorithm functions). The routine 222 selects the optimum one of the algorithm functions in accordance with a function pointer Pb that reflects the current system conditions. The third image-quality processing routine 223 is executed or not executed according to a flag Pc that reflects the current system conditions. The routine 223 can be skipped depending on data to be processed. The image-quality improving routine calling unit 224 calls an image-quality processing routine corresponding to each of the variable Pa, function pointer Pb and flag Pc set by the determining routine 240. The variable Pa, function pointer Pb and flag Pc will be described later.

The CPU load amount checking routine 230 serves as a load amount detecting unit (load detecting unit) that performs a process of checking an amount of load on the CPU 111 at the time of reproduction of a moving image. The routine 230 detects the load on the CPU 111, for example, on a periodical basis. When the load on the CPU 111 varies (increases/decreases), the routine 230 performs a process of notifying the determining routine 240 of the current amount of load on the CPU 111 (CPU load amount).

The determining routine 240 evaluates an amount of data to be processed by the CPU 111 in accordance with the amount of load on the CPU 111, the driving mode and the remaining amount of battery power. A notification about the load on the CPU 111 is provided by the CPU load amount checking routine 230, while a notification about the driving mode and the remaining amount of battery power is provided by the battery checking routine 271.

The determining routine 240 acquires (determines) values corresponding to the driving mode, the remaining amount of battery power and the load on the CPU 111 from the parameter table 250, function pointer table 251 and function skip flag table 252. The acquired values each correspond to an evaluation value of an amount of data to be processed by the CPU 111. In other words, the routine 240 serves as a determining unit for determining (an evaluation value of) an amount of data processing which corresponds to the driving mode, the remaining amount of battery power and the amount of load on the CPU 111. The routine 240 sets the values acquired from the tables 250, 251 and 252 in the image-quality improving routine calling unit 224 as the variable Pa, function pointer Pb and flag Pc.

The parameter table 250 holds a value corresponding to a combination of the driving mode, the remaining amount of battery power and the amount of load on the CPU 111 as a variable (parameter). This variable is used as an argument of the first image-quality processing routine 221 and represents an amount of data processing for the optimum image-quality process for the above combination and a degree of improvement in image quality.

The function pointer table 251 holds a value corresponding to a combination of the driving mode, the remaining amount of battery power and the amount of load on the CPU 111 as a function pointer. The function pointer is an entry pointer and designates an algorithm function for achieving an amount of data processing for the optimum image-quality process for the above combination and a degree of improvement in image quality. The algorithm function is included in the second image-quality processing routine 222.

The function skip flag table 252 holds a flag corresponding to a combination of the driving mode, the remaining amount of battery power and the amount of load on the CPU 111. The flag indicates which of execution and skip of the third image-quality processing routine 223 is selected. The postprocessing routine 260 processes moving image data whose image quality is improved by execution of the image-quality improving routine 220 such that the moving image data can be displayed on the LCD 17 by the graphics controller 114.

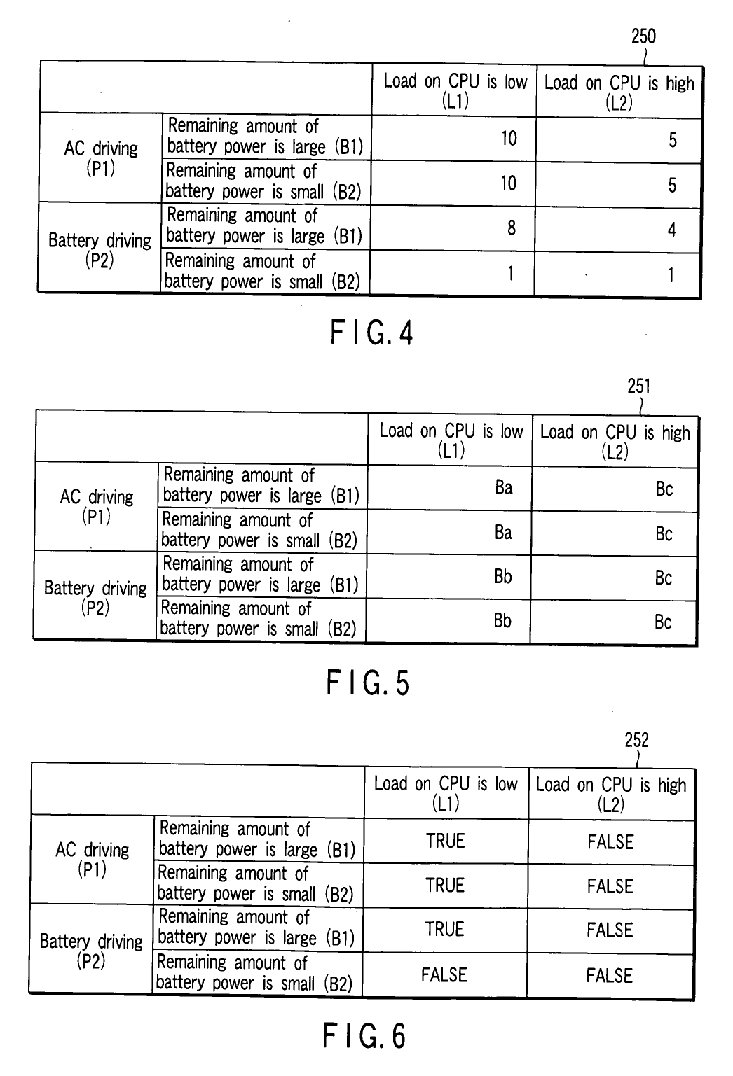

The tables 250, 251 and 252 will be described with reference to FIGS. 4, 5 and 6. FIG. 4 shows an example of a data structure of the parameter table 250. In the present embodiment, the computer 10 has two driving modes: AC driving mode P1 and battery driving mode P2. The CPU 111 has two load conditions: a condition in which the load on the CPU 111 is low (CPU load condition L1) and a condition in which the load on the CPU 111 is high (CPU load condition L2). The battery has two conditions: a condition in which the remaining amount of battery power is large (battery power remaining amount B1) and a condition in which the remaining amount of battery power is small (battery power remaining amount B2).

The parameter table 250 holds a variable (parameter) Pa corresponding to each of all combinations of the driving modes P1 and P2, the CPU load conditions L1 and L2, and the battery power remaining amounts B1 and B2. The variable Pa indicates an amount of data processing for the image-quality process and a degree of improvement in image quality as described above.

In the parameter table 250 shown in FIG. 4, the variable Pa has five values “1,” “4,” “5,” “8” and “10.” When the variable Pa is “10” (maximum value), the amount of data processing for the image-quality process performed by the first image-quality routine 221 is the largest (the load on the CPU 111 is the highest), whereas the degree of improvement in image quality is also the highest. Conversely, when the variable Pa is “1” (minimum value), the amount of data processing for the image-quality process performed by the first image-quality routine 221 is the smallest (the load on the CPU 111 is the lowest), whereas the degree of improvement in image quality is also the lowest.

Referring to FIG. 4, when the driving mode is AC driving mode P1, the variable Pa depends on only the load on the CPU 111 and decreases with increase in the load to prevent the variable Pa from having an influence on other application programs under execution. When the driving mode is battery driving mode P2, the variable Pa depends on the remaining amount of battery power and the load on the CPU 111 and decreases with decrease in the remaining amount of battery power and with increase in the load on the CPU 111. When the remaining amount of battery power is large (B1), the variable Pa in the battery driving mode P2 is smaller than that in the AC driving mode P1 to slightly decrease the amount of data processing. When the remaining amount of battery power is small (B2), the variable Pa is “1” (minimum value) irrespective of the load on the CPU 111.

FIG. 5 shows an example of a data structure of the function pointer table 251. The table 251 holds a function pointer Pb corresponding to each of all combinations of the driving modes P1 and P2, the CPU load conditions L1 and L2 and the battery power remaining amounts B1 and B2. The function pointer Pb indicates an amount of data processing and a degree of improvement in image quality as described above. Referring to FIG. 5, the function pointer Pb has three values “Ba,” “Bb” and “Bc.” The values “Ba,” “Bb” and “Bc” are entry pointers for designating algorithm functions 222a, 222b and 222c, respectively. These algorithm functions are included in the second image-quality processing routine 222.

With the algorithm function 222a, the amount of data processing for the image-quality process is the largest (or the load on the CPU 111 is the highest), whereas the degree of improvement in image quality is also the highest. With the algorithm functions 222b and 222c in the order designated, the amount of data processing decreases, as does the degree of improvement in image quality. Referring to FIG. 5, in AC driving mode P1, the function pointer Pb depends on only the CPU load condition and is set to Ba if the load on the CPU is low (L1) and Bc if it is high (L2). In the battery driving mode P2, too, the function pointer Pb depends on only the CPU load condition and is set to Bb if the load on the CPU is low (L1) and Bc if it is high (L2). In the battery driving mode P2, the function pointer Pb can depend on the battery power remaining amount as well as the CPU load condition.

FIG. 6 shows an example of a data structure of the function skip flag table 252. The table 252 holds a flag Pc corresponding to each of all combinations of the driving modes P1 and P2, the CPU gload conditions L1 and L2 and the battery power remaining amounts B1 and B2. The flag Pc has two conditions “TRUE” and “FALSE.” “TRUE” indicates that the third image-quality processing routine 223 is executed, or the amount of data processing is not zero, while “FALSE” indicates that the third image-quality processing routine 223 is skipped, or the amount of data processing is zero. Referring to FIG. 6, in AC driving mode P1, the flag Pc depends on only the load on the CPU and is set to “TRUE” if the load on the CPU is low (L1) and “FALSE” if it is high (L2). In battery driving mode P2, the flag Pc also depends on the battery power remaining amount and is set to “TRUE” if the load on the CPU is low (L1) and the battery power remaining amount is large (B1) and “FALSE” at all other times.

As described above, in the present embodiment, the battery power remaining amount is classified into two levels of L1 and L2. It can be classified into three or more levels. Similarly, the load on the CPU 111 can be represented in not only two stages but also three or more stages.

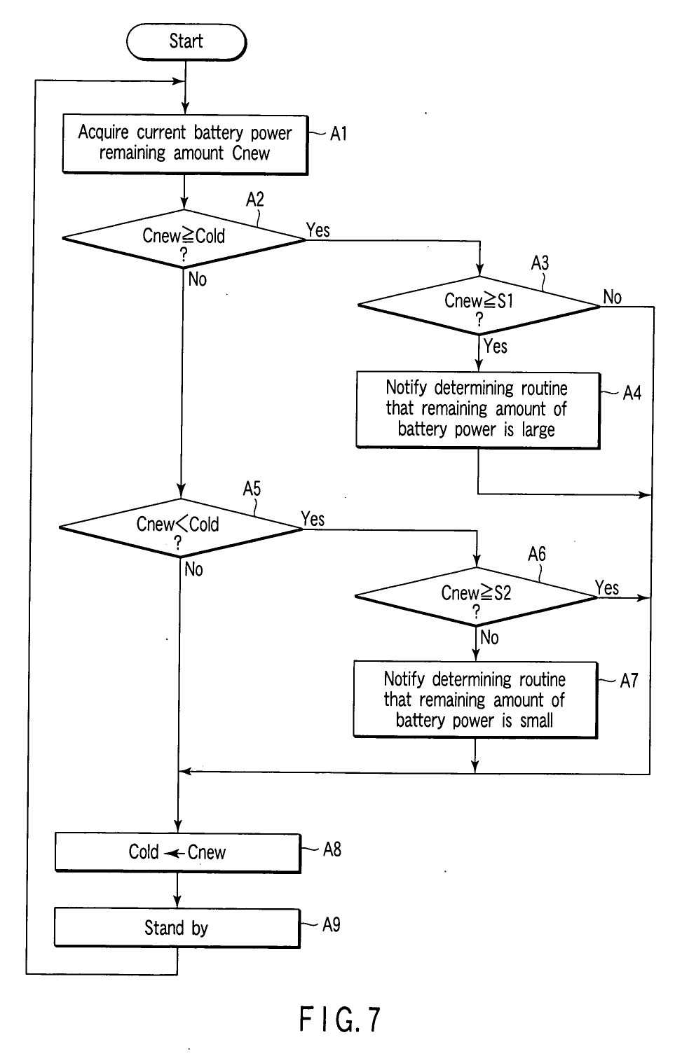

A procedure of the battery checking routine 271 will be described with reference to the flowchart shown in FIG. 7. First, the battery checking routine 271 acquires the current battery power remaining amount Cnew (box A1). The routine 271 compares the currently-acquired battery power remaining amount Cnew and the previously-acquired battery power remaining amount Cold (boxes A2 and A5). If the amount Cnew is equal to or larger than the amount Cold (box A2), the routine 271 determines that the battery 126 is being charged. Then, the routine 271 compares the amount Cnew with a threshold value S1 used when the battery is charged (box A3). If the amount Cnew is equal to or larger than S1, the routine 271 notifies the determining routine 240 that the battery power remaining amount of the battery 126 is large (battery power remaining amount B1) (box A4).

If the amount Cnew is smaller than the amount Cold (box A5), the battery checking routine 271 determines that the battery 126 is being discharged. Then, the routine 271 compares the amount Cnew with a threshold value S2 used when the battery is discharged (box A6). The threshold value S2 is set larger than the threshold value S1, considering that the battery power remaining amount decreases further. If the amount Cnew is smaller than the threshold value S2, the routine 271 notifies the determining routine 240 that the amount of power remaining in the battery 126 is small (battery power remaining amount B2) (box A7).

If the amount Cnew is equal to or larger than the amount Cold and smaller than the threshold value S1 (boxes A2 and A3), or if the amount Cnew is smaller than the amount Cold and equal to or larger than the threshold value S2 (boxes A5 and A6), the battery checking routine 271 determines that the battery power remaining amount is the same as the previous battery power remaining amount and does not notify the determining routine 240 of the battery power remaining amount.

After the above processing, the battery checking routine 271 updates the amount Cold to the current amount Cnew for the next processing (box A8). Then, the routine 271 stands by for a given period of time (box A9) and returns to box A1 to repeat the above processing. In other words, the routine 271 repeats the procedure indicated in the flowchart of FIG. 7 every time period (periodically).

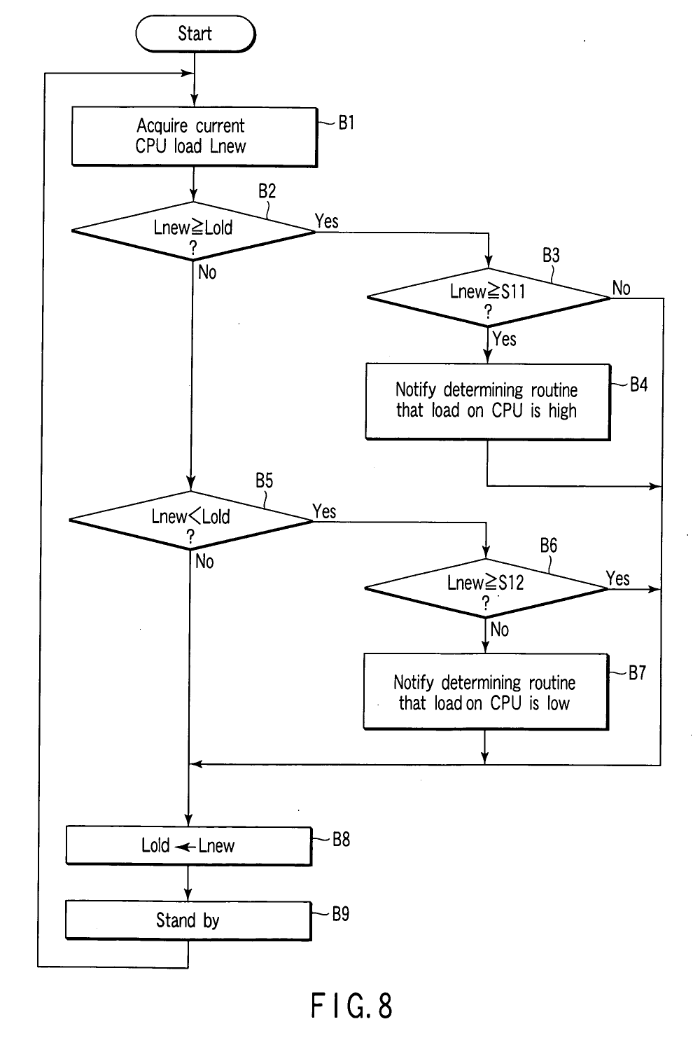

A procedure of the CPU load amount checking routine 230 will be described with reference to the flowchart shown in FIG. 8. First, the CPU load amount checking routine 230 currently acquires an amount Lnew of load on the CPU 111 (CPU load amount) (box B1). The routine 230 compares the currently-acquired CPU load amount Lnew and the previously-acquired CPU load amount Lold (boxes B2 and B5). If the amount Lnew is equal to or larger than the amount Lold, the routine 230 determines that the CPU 111 is increasing in temperature. Then, the routine 230 compares the amount Lnew with a threshold value S11 obtained when the CPU 111 is increasing in temperature (box B3). If the amount Lnew is equal to or larger than S1, the routine 230 notifies the determining routine 240 that the load on the CPU 111 is high (box B4).

If the amount Lnew is smaller than the amount Lold (box B5), the CPU load amount checking routine 230 determines that the CPU 111 is decreasing in temperature. Then, the routine 230 compares the amount Lnew with a threshold value S12 obtained when the CPU 111 is decreasing in temperature (box B6). The threshold value S12 is set larger than the threshold value S11, considering that the load on the CPU lowers further. If the amount Lnew is smaller than the threshold value S12, the routine 230 notifies the determining routine 240 that the load on the CPU 111 is low (box B7).

If the amount Lnew is equal to or larger than the amount Lold and smaller than the threshold value S11 (boxes B2 and B3), or if the amount Lnew is smaller than the amount Lold and equal to or larger than the threshold value S12 (boxes B5 and B6), the CPU load amount checking routine 230 determines that the CPU load condition is the same as the previous CPU load condition and does not notify the determining routine 240 of the load on the CPU.

After the above processing, the CPU load amount checking routine 230 updates the amount Lold to the current amount Lnew for the next processing (box B8). Then, the routine 230 stands by for a given period of time (box B9) and returns to box B1 to repeat the above. processing. In other words, the routine 230 repeats the procedure indicated in the flowchart of FIG. 8 every time period (periodically).

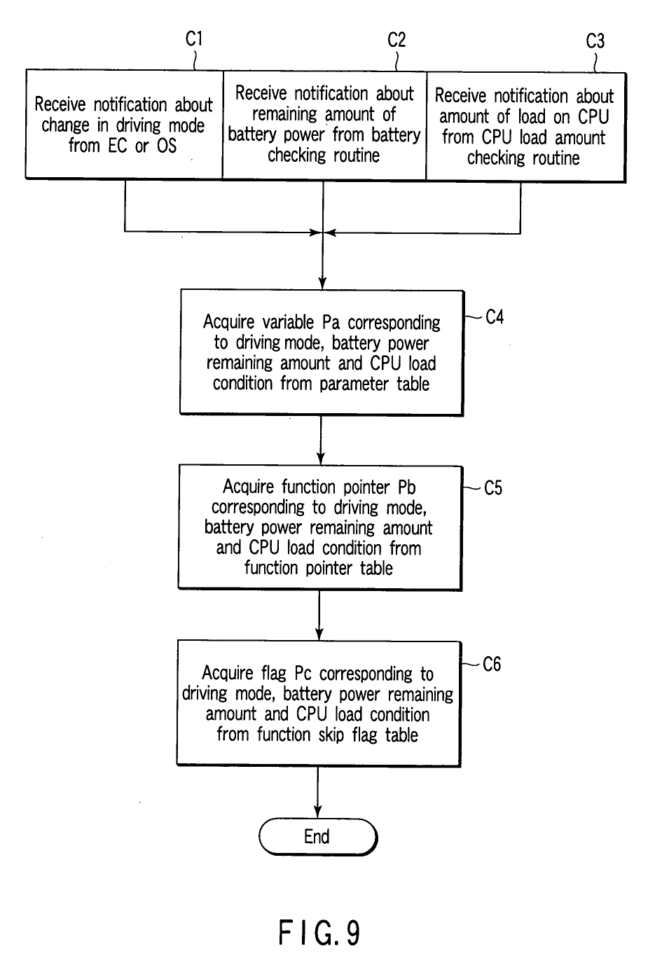

A procedure of the determining routine 240 will be described with reference to the flowchart shown in FIG. 9. The determining routine 240 receives a notification about a change in driving mode (type of power supply for use) from the embedded controller (EC) or the operating system (OS) (box C1). The change in driving mode indicates that the driving mode is switched from the battery driving mode P2 (battery 126) to the AC driving mode P1 (AC power supply) or from the AC driving mode P1 (AC power supply) to the battery driving mode P2 (battery 126). The routine 240 also receives a notification about the current battery power remaining amount from the battery checking routine 271 (box C2). Further, the routine 240 receives a notification about the current load condition of the CPU 111 from the CPU load amount checking routine 230 (box C3).

The determining routine 240 acquires a variable Pa corresponding to a combination of the driving mode, the battery power remaining amount and the CPU load condition, the notifications of which are received in boxes C1 to C3, from the parameter table 250 (box C4). The variable Pa is an argument of the first image-quality processing routine 221.

Similarly, the determining routine 240 acquires a function pointer Pb corresponding to a combination of the driving mode, the battery power mount and the CPU load condition, the notifications of which are received in boxes C1 to C3, from the function pointer table 251 (box CS). The function pointer Pb is an entry pointer for designating an algorithm function included in the second image-quality processing routine 222.

The determining routine 240 acquires a flag Pc corresponding to a combination of the driving mode, the battery power remaining amount and the CPU load condition, the notifications of which are received in boxes C1 to C3, from the function skip flag table 252 (box C6). The flag Pc indicates whether to execute the third image-quality processing routine 223.

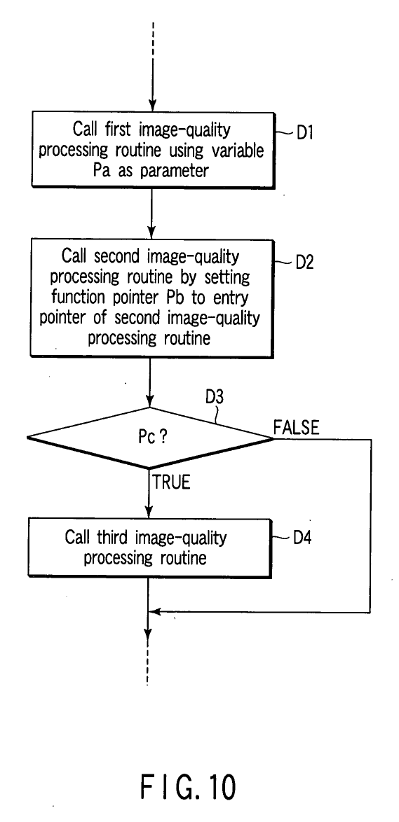

An operation of the image-quality improving routine calling unit 224 will be described with reference to the flowchart shown in FIG. 10. The image-quality improving routine calling unit 224 calls the first image-quality processing routine 221 using the variable Pa set by the determining routine 240 as a parameter (argument) (box D1). Then, the routine 221 performs a process of improving the image quality of a moving image (image-quality process) using the variable Pa as a parameter. The routine 221 is characterized in that its procedure of the image-quality process is a single one and a parameter is referred to in the process. The degree of improvement in image quality and the amount of data processing vary with the parameter. The image quality can thus be improved in accordance with the system condition by a combination of the driving mode, the battery power remaining amount and the CPU load condition, or the optimum amount of data processing for the system condition.

In the present embodiment, the first image-quality processing routine 221 performs an interlace progressive (IP) conversion process. In the IP conversion process, an interlace video image that composes video data such as TV broadcast program data is converted to a progressive video image. The progressive video image is video data displayed on the display monitor (LCD 17) of the computer 10. Particularly in the IP conversion process of the first image-quality processing routine 221, an area to be referred to is varied with the set parameter (variable) Pa, as is the number of frames before and after a target frame, which are to be referred to.

Referring to the parameter table 250 shown in FIG. 4, when the driving mode is the AC driving mode P1 and the load on the CPU 111 is low (L1), the parameter (variable) Pa is the maximum value “10”. The area to be referred to in the IP conversion process (process of the first image-quality processing routine 221) becomes the largest and so does the number of frames before and after a target frame, which are to be referred to. Though the amount of data processing is the largest, the maximum improvement in image quality can be obtained. Referring also to the table shown in FIG. 4, when the driving mode is the battery driving mode P2, the battery power remaining amount is small (B2) and the load on the CPU 111 is high (L2), the parameter (variable) Pa is the minimum value “1”. The area to be referred to in the IP conversion process (process of the first image-quality processing routine 221) becomes the smallest and so does the number of frames before and after a target frame, which are to be referred to. Though the degree of improvement in image quality is low, the amount of data processing can be reduced the most. Though the amount of data processing increases with increase in parameter (variable) Pa, the degree of improvement in image quality becomes high. In contrast, though the degree of improvement decreases with decrease in parameter (variable) Pa, the amount of data processing can be reduced.

The image-quality improving routine calling unit 224 calls the function pointer Pb set by the determining routine 240 as an entry pointer (box D2). Then, the second image-quality processing routine 222 performs a process of improving the image quality of a moving image in accordance with one of the algorithm functions 222a, 222b and 222c designated by the function pointer Pb. The image quality can thus be improved in accordance with the condition of the system by a combination of the driving mode, the remaining amount of battery power and the CPU load condition, or the optimum amount of data processing for the system condition.

In the present embodiment, the algorithm functions 222a, 222b and 222c are used for a sharpness process for edge enhancement. Referring to the function pointer table 251 shown in FIG. 5, when the driving mode is the AC driving mode P1 and the load on the CPU 111 is low (L1), the function pointer (entry pointer) Pb is Ba. Though the amount of data processing becomes the highest in accordance with the algorithm 222a designated by Ba, the sharpness process is performed to obtain the highest degree of edge enhancement. Referring also to the table shown in FIG. 5, when the load on the CPU 111 is high (L2), the function pointer (entry pointer) Pb is Bc irrespective of the driving mode and the battery power remaining amount. Though the degree of edge enhancement is lowered in accordance with the algorithm function 222c designated by Bc, the sharpness process is performed to make the amount of data processing the smallest.

The image-quality improving routine calling unit 224 determines whether to execute the third image-quality processing routine 223 according to the condition of the flag Pc set by the determining routine 240 (box D3). If the condition of the flag Pc is “FALSE,” the unit 224 is inhibited from calling the routine 223 not to execute the third image-quality processing routine 223. Thus, the process of the third image-quality processing routine 223 is skipped to prevent the amount of data processing from being increased by the process of the routine 223. In contrast, if the condition of the flag Pc is “TRUE,” the image-quality improving routine calling unit 224 calls the routine 223 to execute the third image-quality processing routine 223 (box D4). Thus, the routine 223 is executed and the amount of data processing is increased, but the image quality can be improved.

In the present embodiment, the third image-quality processing routine 223 performs a deblocking process of reducing block noise, which can be skipped depending on the system condition. The effect of a deblocking filter obtained by the deblocking process depends on the source of moving image data. If the source of moving image data is DVD media or digital broadcasting, block noise contained in decoded moving image data is low, unlike in analog broadcasting. In this case, the effect of the deblocking filter for reducing block noise is not produced remarkably.

In the present embodiment, when the load on the CPU 111 is high (L2), the flag Pc is set in “FALSE” irrespective of the driving mode and the battery power remaining amount to inhibit the third image-quality processing routine 223 from being executed. Even when the load on the CPU 111 is low (L1), if the driving mode is the battery driving mode and the battery power remaining amount is small (B2), the flag Pc is set in “FALSE” to inhibit the third image-quality processing routine 223 from being executed.

According to the embodiment of the invention, when a moving image is reproduced by the moving image reproducing application program 201, a process of improving the image quality of the moving image (image-quality process) is optimized in accordance with the load condition of the CPU 111 and the conditions of the power supply of the computer 10. The conditions of the power supply are the driving mode, which depends on the type of power supply for use, and the battery power remaining amount. In other words, the image-quality process is performed by the optimum amount of data processing for the system condition. Consequently, a moving image of optimum quality for the system condition can be reproduced and its image quality can be prevented from being degraded by a drop in frame due to low throughput of the system. The image-quality process is performed by the optimum amount of data processing for the system condition. Therefore, when the CPU 111 executes an application program while executing the moving image reproducing application program 201, a moving image of optimum quality for the condition of the system can be reproduced without hindering the execution of the former application program.

In the present embodiment, an amount of data processing for the image-quality process can be varied between the AC driving mode in which the battery power remaining amount need not be considered and the battery driving mode in which it has to be done. In other words, the driving mode can automatically be selected between the AC driving mode in which the amount of data to be processed is increased to give priority to high image quality and the battery driving mode in which the amount is decreased to give priority to low power consumption.

In the present embodiment, the load condition of the CPU 111 and the conditions of the power supply of the computer 10 (the driving mode depending on the type of power supply for use, and the battery power remaining amount) are handled as the system condition. However, the system condition does not always include the condition of the power supply of the computer 10.

While certain embodiments of the inventions have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and apparatuses described herein may be made without departing from spirit of the inventions. The accompanying claims and their equivalents are intended to cover such forms or modifications as would fall within the scope and spirit of the inventions.

What is claimed is:

1. An information processing apparatus that reproduces moving image data, comprising:
a memory which stores a plurality of application programs including a moving image reproducing application program to reproduce moving image data, the moving image reproducing application program including an image-quality improving routine in which an amount of data processing for an image-quality process of improving image quality of a moving image is changed;
a processor which executes the application programs concurrently with each other;
a load detecting unit configured to detect an amount of load on the processor; and
a determining unit configured to determine an optimum amount of data processing for the image-quality process executed by the image-quality improving routine, in accordance with a system condition including the amount of load on the processor detected by the load detecting unit.

2. The information processing apparatus according to claim 1, wherein the determining unit determines the optimum amount of data processing for the image-quality process such that the amount of data processing decreases with increase in the amount of load on the processor.

3. The information processing apparatus according to claim 1, further comprising a power supply condition detecting unit configured to detect a condition of a power supply of the information processing apparatus,
wherein the system condition further includes the condition of the power supply detected by the power supply condition detecting unit.

4. The information processing apparatus according to claim 3, wherein the power supply condition detecting unit detects which of an alternating-current driving mode in which the information processing apparatus is driven by an external alternating-current power supply and a battery driving mode in which the information processing apparatus is driven by a battery is used and detects a remaining mount of power of the battery, as the condition of the power supply of the information processing apparatus.

5. The information processing apparatus according to claim 4, wherein the determining unit determines an optimum amount of data processing for the image-quality process such that the amount of data processing decreases with increase in the amount of load on the processor in the alternating-current driving mode and an optimum amount of data processing for the image-quality process such that the amount of data processing decreases with increase in the amount of load on the processor and decrease in the remaining mount of power of the battery in the battery driving mode.

6. The information processing apparatus according to claim 1, wherein:
the image-quality improving routine includes an image-quality processing routine to perform an image-quality process of improving given image quality of a moving image, the image-quality processing routine allowing an amount of data processing for the image-quality process to be selected in accordance with a parameter set from outside; and
the information processing apparatus further comprises a calling unit configured to call the image-quality processing routine by passing a parameter corresponding to the amount of data to be processed, determined by the determining unit to the image-quality processing routine as an argument.

7. The information processing apparatus according to claim 6, further comprising a parameter table which holds a parameter corresponding to each of a plurality of system conditions determined in advance,
wherein the determining unit acquires a parameter corresponding to a system condition including the amount of load on the processor detected by the load detecting unit by referring to the parameter table.

8. The information processing apparatus according to claim 1, wherein:
the image-quality improving routine includes an image-quality processing routine having a plurality of algorithm functions to perform an image-quality process of improving given image quality of a moving image, the algorithm functions varying in amount of data processing and effect of improvement in image quality; and
the information processing apparatus further comprises a calling unit configured to call one of the algorithm functions, which corresponds to the amount of data processing, determined by the determining unit, by a function pointer corresponding to the amount of data processing.

9. The information processing apparatus according to claim 8, further comprising a function pointer table which holds a function pointer corresponding to each of a plurality of system conditions determined in advance,
wherein the determining unit acquires a parameter corresponding to a system condition including the amount of load on the processor detected by the load detecting unit by referring to the function pointer table.

10. The information processing apparatus according to claim 1, wherein:
the image-quality improving routine includes an image-quality processing routine to perform a given image-quality process whose effects of improvement in image quality differ with a source of a moving image to be reproduced;
the determining unit determines one of a nonzero value and a zero value as an amount of data processing in accordance with the system condition including the amount of load on the processor detected by the load detecting unit; and
the information processing apparatus further comprises a calling unit configured to call or skip the image-quality processing routine in accordance with one of the nonzero value and the zero value determined by the determining unit.

11. The information processing apparatus according to claim 10, further comprising a flag table which holds a flag indicating one of the nonzero value and the zero value and corresponding to each of a plurality of system conditions determined in advance, and wherein:
the determining unit acquires a flag corresponding to a system condition including the amount of load on the processor detected by the load detecting unit by referring to the flag table; and
the calling unit calls or skips the image-quality processing routine in accordance with a condition of the flag acquired by the determining unit.

12. A method of reproducing moving image data by causing a processor included in an information processing apparatus to execute a moving image reproducing application program, the moving image reproducing application program including an image-quality improving routine in which an amount of data processing for an image-quality process of improving image quality of a moving image is changed, the method comprising:
detecting an amount of load on the processor; and
determining an optimum amount of data processing for the image-quality process executed by the image-quality improving routine, in accordance with a system condition including the detected amount of load on the processor.

13. The method according to claim 12, further comprising detecting a condition of a power supply of the information processing apparatus,
wherein the system condition further includes the detected condition of the power supply.

14. The method according to claim 13, wherein the condition of the power supply includes a condition of detecting which of an alternating-current driving mode in which the information processing apparatus is driven by an external alternating-current power supply and a battery driving mode in which the information processing apparatus is driven by a battery is used and a condition of detecting a remaining amount of power of the battery, as the condition of the power supply of the information processing apparatus.

15. The method according to claim 14, wherein an optimum amount of data processing is determined for the image-quality process such that the amount of data processing decreases with increase in the amount of load on the processor in the alternating-current driving mode, and an optimum amount of data processing is determined for the image-quality process such that the amount of data processing decreases with increase in the amount of load on the processor and decrease in the remaining amount of power of the battery in the battery driving mode.

16. The method according to claim 12, wherein:
the image-quality improving routine includes an image-quality processing routine to perform an image-quality process of improving given image quality of a moving image, the image-quality processing routine allowing an amount of data processing for the image-quality process to be selected in accordance with a parameter set from outside; and
the method further comprises calling the image-quality processing routine by passing a parameter corresponding to the determined amount of data to be processed, to the image-quality processing routine as an argument.

17. The method according to claim 12, wherein:
the image-quality improving routine includes an image-quality processing routine having a plurality of algorithm functions to perform an image-quality process of improving given image quality of a moving image, the algorithm functions varying in amount of data processing and effect of improvement in image quality; and
the method further comprises calling one of the algorithm functions, which corresponds to the determined amount of data processing, by a function pointer corresponding to the amount of data processing.

18. The method according to claim 12, wherein:
the image-quality improving routine includes an image-quality processing routine to perform a given image-quality process whose effects of improvement in image quality differ with a source of a moving image to be reproduced;
one of a nonzero value and a zero value is determined as an amount of data processing in accordance with the system condition including the detected amount of load on the processor; and
the method further comprises calling or skipping the image-quality processing routine in accordance with the determined one of the nonzero value and the zero value.
